(19) United States
(12) Patent Application Publication
(10) Pub. No.: US 2022/0264349 A1
(43) Pub. Date: Aug. 18, 2022

(54) Methods and Devices for Wireless Communication

(71) Applicant: Telefonaktiebolaget LM Ericsson (publ), Stockholm (SE)

(72) Inventors: Jinhua Liu, Beijing (CN); Min Wang, Luleå (SE)

(21) Appl. No.: 17/625,882

(22) PCT Filed: Mar. 13, 2020
(86) PCT No.: PCT/CN2020/079286

§ 371 Date: Jan. 10, 2022

(30) Foreign Application Priority Data
Jul. 11, 2019 (CN) PCT/CN2019/095535

(51) Int. Cl. H04W 24/10

(52) U.S. Cl. CPC H04W 24/10

(57) ABSTRACT

The present disclosure provides a method (100) at a terminal device. The method (100) includes: determining (110) a demand to transmit a report indicating channel occupancy; generating (120) the report indicating the channel occupancy in response to the demand; and transmitting (130) the report to a network device.

### TECHNICAL FIELD

The present disclosure relates to wireless communication, and more particularly, to wireless communication in unlicensed spectrum.

### BACKGROUND

Radio spectrum is a scarce resource, and thus allowing cellular transmissions in unlicensed spectrum (e.g., Wi-Fi frequency bands) to effectively use the available spectrum is an attractive approach to increase system capacity. Although unlicensed spectrum may not match the qualities of the licensed regime, solutions that allow an efficient use of it as a complement to licensed deployments have the potential to bring great value to the operators and industry. Thus, it is important to support operations in unlicensed spectrum in many scenarios. For example, 5G New Radio (NR) is targeting both licensed and unlicensed bands, and a work item named NR-based Access to Unlicensed Spectrum (NR-U) has been started.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Methods, devices, computer-readable storage media and computer program products are provided to improve the scheduling in unlicensed spectrum.

In a first aspect of the present disclosure, a method at a terminal device is provided. The method may include determining a demand to transmit a report indicating channel occupancy, generating the report indicating the channel occupancy in response to the demand, and transmitting the report to a network device.

According to an embodiment, the demand may correspond to a need to perform data transmission or receiving by the terminal device.

According to an embodiment, the method may further comprise receiving a notification from the network device informing scheduling information for the terminal device, wherein the scheduling information is determined based at least on the report.

According to an embodiment, the demand may be determined in response to at least one of: a schedule request (SR) being triggered; a regular buffer status report (BSR) being triggered; a periodic BSR being triggered which indicates an existence of buffered data for uplink (UL) transmission; receiving from the network device a notification that requests the report indicating the channel occupancy; receiving from the network device the first downlink control information (DCI) of one or more DCIs for UL grants or downlink (DL) assignments; an expiration of a previous report and an existence of data to be transmitted in UL or to be received in DL; and a change between a current channel occupancy and a previously reported channel occupancy beyond a threshold and an existence of data to be transmitted in UL or to be received in DL.

According to an embodiment, the notification that requests the report indicating the channel occupancy may be carried in DCI, media access control (MAC) control element (MAC CE) and/or radio resource control (RRC) signaling.

According to an embodiment, the report may comprise a bitmap to indicate availability of one or more channels.

According to an embodiment, the report may be transmitted using a MAC CE.

According to an embodiment, the MAC CE may be prioritized over data transmission in a MAC protocol data unit (PDU) when UL data in a transmit buffer of the terminal device exceeds a size of the MAC PDU.

According to an embodiment, the report may be transmitted via at least one of: physical uplink control channel (PUCCH), physical uplink shared channel (PUSCH), and random access (RA) message.

According to an embodiment, the report may be transmitted only indicating the channel occupancy for a channel having a lowest channel occupancy and/or for non-scheduled channels.

According to an embodiment, the report may be generated for one of the following: channels in an active bandwidth part (BWP); channels in an active carrier; channels in a configured carrier; and channels in an active carrier and one or more carriers corresponding to other serving cells.

According to an embodiment, the report may comprise information related to at least one of: listen-before-talk (LBT) failure statistics, LBT success statistics, average receiving power, and duty cycle.

According to an embodiment, the report may be generated per subband, per channel, per BWP, per component carrier or per carrier.

According to an embodiment, generating the report may comprise: measuring at least one parameter associated with the channel occupancy over a slot, a mini-slot, a symbol, a radio frame or a predetermined period.

According to an embodiment, the method may further comprise receiving, prior to the determining, from the network device a message to enable the report indicating the channel occupancy.

According to an embodiment, the message may comprise parameters to configure triggering, generation and/or transmission of the report.

In a second aspect of the present disclosure, a method at a network device is provided. The method may include receiving a report indicating channel occupancy from a terminal device and performing scheduling for the terminal device based at least on the report. The report may be generated by the terminal device in response to a demand for the report.

In a third aspect of the present disclosure, a terminal device is provided. The terminal device may include a processor and a memory configured to store instructions. The instructions, when executed by the processor, cause the terminal device to determine a demand to transmit a report indicating channel occupancy, generate the report indicating the channel occupancy in response to the demand, and transmit the report to a network device.

In a fourth aspect of the present disclosure, a network device is provided. The network device may include a processor and a memory configured to store instructions. The instructions, when executed by the processor, cause the network device to receive a report indicating channel occupancy from a terminal device and perform scheduling for the terminal device based at least on the report. The report may be generated by the terminal device in response to a demand for the report.

In a fifth aspect of the present disclosure, a computer readable storage medium is provided. The computer readable storage medium has instructions stored thereon, which, when executed by a processor of a terminal device, cause the terminal device to perform the method according to the above first aspect.

In a sixth aspect of the present disclosure, a computer readable storage medium is provided. The computer readable storage medium has instructions stored thereon, which, when executed by a processor of a network device, cause the network device to perform the method according to the above second aspect.

In a seventh aspect of the present disclosure, an apparatus is provided. The apparatus may include a determining unit, a generating unit and a transmitting unit. The determining unit may be configured to determine a demand to transmit a report indicating channel occupancy. The generating unit may be configured to generate the report indicating the channel occupancy in response to the demand. The transmitting unit may be configured to transmit the report to a network device.

In an eighth aspect of the present disclosure, an apparatus is provided. The apparatus may include a receiving unit and a scheduling unit. The receiving unit may be configured to receive a report indicating channel occupancy from a terminal device and the scheduling unit may be configured to perform scheduling for the terminal device based at least on the report. The report may be generated by the terminal device in response to a demand for the report.

In a ninth aspect of the present disclosure, a communication system including a host computer is provided. The host computer includes processing circuitry configured to provide user data, and a communication interface configured to forward the user data to a cellular network for transmission to a user equipment (UE). The UE includes a radio interface and processing circuitry. The UE's processing circuitry may be configured to determine a demand to transmit a report indicating channel occupancy, generate the report indicating the channel occupancy in response to the demand, and transmit the report to a base station.

In a tenth aspect of the present disclosure, a method implemented in a communication system including a host computer, a base station and a UE is provided. The method may include, at the host computer, providing user data at the host computer, and initiating a transmission carrying the user data to the UE via a cellular network comprising the base station. The UE may determine a demand to transmit a report indicating channel occupancy, generate the report indicating the channel occupancy in response to the demand, and transmit the report to the base station.

In an eleventh aspect of the present disclosure, a communication system including a host computer is provided. The host computer includes processing circuitry configured to provide user data, and a communication interface configured to forward the user data to a cellular network for transmission to a UE. The cellular network comprises a base station having a radio interface and processing circuitry. The base station's processing circuitry may be configured to receive a report indicating channel occupancy from the UE and perform scheduling for the UE based at least on the report. The report may be generated by the UE in response to a demand for the report.

In a twelfth aspect of the present disclosure, a method implemented in a communication system including a host computer, a base station and a UE is provided. The method may include, at the host computer, providing user data at the host computer, and initiating a transmission carrying the user data to the UE via a cellular network comprising the base station. The base station may receive a report indicating channel occupancy from the UE and perform scheduling for the UE based at least on the report. The report may be generated by the UE in response to a demand for the report.

With the embodiments of the present disclosure, an on-demand channel occupancy report can be timely transmitted to the network device. As such, the probability of scheduling an available channel for the terminal device can be increased.

### BRIEF DESCRIPTION OF THE DRAWINGS

The above and other objects, features and advantages will be more apparent from the following description of embodiments with reference to the figures, in which:

FIG. 1 is a flowchart illustrating a method at a terminal device according to embodiments of the present disclosure;

FIG. 2 is a schematic diagram illustrating an example bitmap used for the channel occupancy report according to embodiments of the present disclosure;

FIG. 3 is a schematic diagram showing an example procedure of UL data transmission according to embodiments of the present disclosure;

FIG. 4 is a flowchart illustrating a method at a network device according to embodiments of the present disclosure;

FIG. 5 is a block diagram illustrating an exemplary terminal device according to embodiments of the present disclosure;

FIG. 6 is a block diagram illustrating an exemplary network device according to embodiments of the present disclosure;

FIG. 7A-7B are block diagrams illustrating exemplary apparatuses that can respectively perform the method of FIGS. 1 and 4 according to embodiments of the present disclosure;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10 to 13 are flowcharts illustrating methods implemented in a communication system including a host computer, a base station and a user equipment.

### DETAILED DESCRIPTION

As used herein, the term “wireless communication network” refers to a network following any suitable wireless communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), LTE, and/or other suitable 1G, 2G, 2.5G, 2.75G, 3G, 4G, 4.5G, 5G, 6G communication protocols; wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network device” or “network node” refers to a device in a communication network via which a terminal device accesses the network and receives services therefrom. Examples of the network device may include a base station (BS), an access point (AP), or any other suitable device in the wireless communication network. The BS may be, for example, a node B (NodeB or NB), an evolved NodeB (eNodeB or eNB), a next generation NodeB (gNodeB or gNB), a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes, positioning nodes or the like. More generally, however, the network device may represent any suitable device (or group of devices) capable, configured, arranged, and/or operable to enable and/or provide a terminal device access to the wireless communication network or to provide some service to a terminal device that has access to the wireless communication network.

The term “terminal device” refers to any end device that can access a wireless communication network and receive services therefrom. By way of example and not limitation, the terminal device may refer to a mobile terminal, a user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, mobile phones, cellular phones, smart phones, tablets, personal digital assistants (PDAs), wearable devices, vehicle-mounted wireless terminal devices, wireless endpoints, or the like.

In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. As a further example, a UE may represent a device that is intended for sale to, or operation by, a human user but that may not initially be associated with a specific human user.

As yet another example, in an Internet of Things (loT) scenario, a terminal device may represent a machine or other device that performs monitoring, sensing and/or measurements, and transmits the results of such monitoring, sensing and/or measurements to another terminal device and/or network equipment. The terminal device may in this case be a machine-to-machine (M2M) device, which may in a 3GPP context be referred to as a machine-type communication (MTC) device.

As used herein, a downlink transmission refers to a transmission from a network device to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

When operating in unlicensed spectrum, it may be helpful for a radio device (e.g., a network device or a terminal device) to sense the transmission medium as free before transmitting, which may be referred to as listen-before-talk (LBT). LBT is designed for unlicensed spectrum co-existence with other RATs. In this mechanism, a radio device applies a clear channel assessment (CCA) check (i.e. channel sensing) before any transmission. The CCA check may involve energy detection (ED) over a time period compared to a certain threshold (ED threshold, e.g., −62 dBm) in order to determine if a channel is idle. Usually, the sensing is done in a particular channel (corresponding to a defined carrier frequency) and over a predefined bandwidth. For example, in the 5 GHz band, the sensing is done over 20 MHz channels.

A terminal device (e.g., a UE) may periodically report the LBT statistics (or other channel occupancy measurement results) to a network device (e.g., a gNB) for the channel allocated to the terminal device. Based on the received report, the serving network device can have the knowledge of the occupancy of different channels and thus can schedule a channel with lower channel occupancy for a terminal device. However, the periodic report has some disadvantages when it is used for channel selection, especially in the case of dynamic scheduling. In particular, the periodic measurement with filtering in a long period may not well reflect the latest channel availability when there is an immediate data transmission requirement. Uplink (UL) grants allocated according to the periodic channel occupancy report may be blocked because the scheduled channel may be occupied by other devices. Moreover, the periodic report requires the terminal device carry measurements regardless whether there is data to be transmitted or not, causing a power consumption cost for the terminal device even when it has no data to be transmitted in a certain period.

Therefore, it may be desirable to find a way to schedule a channel with a high channel availability probability. It may also be desirable to find a way to reduce the power consumption of the terminal device for channel occupancy monitoring.

Embodiments of the present disclosure provide methods and devices to perform on-demand channel occupancy report instead of the periodic report.

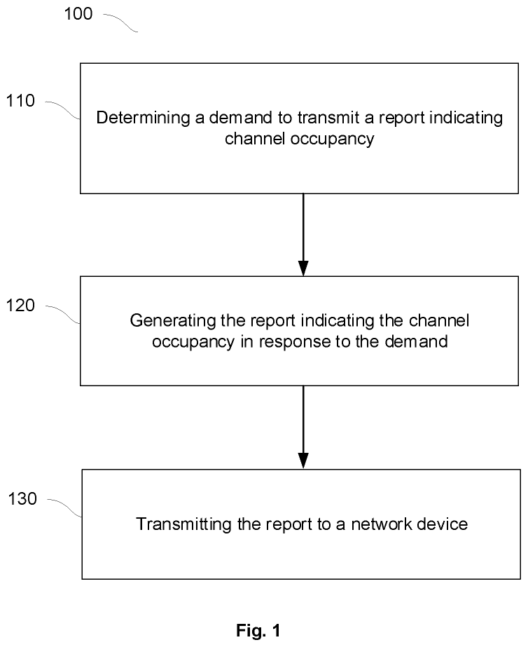

FIG. 1 is a flowchart illustrating a method 100 according to embodiments of the present disclosure. The method 100 can be performed at a terminal device, e.g., a UE.

At block 110, a demand to transmit a report indicating channel occupancy may be determined. At block 120, the terminal device may generate the report indicating the channel occupancy in response to the demand. At block 130, the terminal device may transmit the report to a network device. Upon receiving the report from the terminal device, the network device can perform scheduling for the terminal device based at least on the report.

In this way, the probability of scheduling an available channel for the terminal device can be increased as compared with the periodic report, because the on-demand report can better reflect the latest channel availability for an immediate transmission requirement. Moreover, the power consumption of the terminal device can be reduced because the measurement and report of channel occupancy occurs in response to a demand instead of being performed periodically. The overhead due to the periodic report can also be reduced.

According to an embodiment, the network device may transmit a message to the terminal device to enable the on-demand report as described in blocks 110-130. For example, the network device may transmit a configuration message to the terminal device indicating parameters of the report. Accordingly, the method 100 may further include, prior to block 110, receiving a message from the network device to enable the report indicating the channel occupancy. For example, prior to block 110, the terminal device may receive a configuration message from the network device which indicates parameters of the report.

According to an embodiment, the network device may transmit a message to configure the on-demand report triggering, generation and/or transmission. For example, the message may comprise at least one of the radio resource for on-demand report transmission, the format of on-demand report, the conditions that trigger the on-demand report and the metric to indicate the channel occupancy (e.g., the average received power during a time interval and/or LBT failure etc.). As an example, RRC message may be used to configure these parameters.

According to an embodiment, the method 100 may further include receiving a notification from the network device informing information of the scheduling for the terminal device. With the notification, the terminal device can perform data transmission or data receiving accordingly.

According to an embodiment, the demand to transmit the report indicating the channel occupancy may correspond to a need to perform data transmission or receiving by the terminal device. Some examples will be described below to show when it is determined that there is a demand to transmit the report.

In an example, the demand may be determined in response to a schedule request (SR) being triggered and/or a regular buffer status report (BSR) being triggered.

In another example, the demand may be determined in response to a periodic BSR being triggered, which indicates an existence of buffered data for UL transmission, i.e., a non-zero buffer status.

In another example, the demand may be determined in response to receiving from the network device a notification that requests the report indicating the channel occupancy. The notification may be carried in downlink control information (DCI), media access control (MAC) control element (MAC CE) and/or radio resource control (RRC) signaling. For this purpose, a new DCI format or a new MAC CE format may be defined to include one or more explicit indicators on the requested report.

In another example, the demand may be determined in response to receiving from the network device the first DCI of one or more DC's for UL grants or downlink (DL) assignments. For example, the network device (e.g., a gNB) may send one or more consecutive DC's to the terminal device (e.g., a UE) for UL grants or DL assignments. Upon reception of the first DCI, the UE may send the report indicating the channel occupancy to the gNB to assist subsequent scheduling decision for this UE. In this embodiment, there may be no explicit indicators on the requested report, but instead, the trigger of the report is implicit.

In another example, the demand may be determined in response to an expiration of a previous report and an existence of data to be transmitted in UL or to be received in DL. Specifically, when the terminal device (e.g., a UE) has data to be transmitted in UL (e.g., the UE has a non-empty buffer) or has data to be received in DL but the previously transmitted report is outdated, a new report may be required at the network device to reflect the latest channel occupancy and thus help the scheduling. To monitor the expiration of the report, a timer may be introduced to record the elapsed time. When the timer expires, i.e., the elapsed time since the previous report is larger than a predefined threshold, which means that the previous report is outdated, a new report is expected when there is data to be transmitted in UL or to be received in DL.

In another example, the demand may be determined in response to a change between a current channel occupancy and a previously reported channel occupancy beyond a threshold and an existence of data to be transmitted in UL or to be received in DL. For example, when the terminal device (e.g., a UE) has data to be transmitted in UL (e.g., the UE has a non-empty buffer) or has data to be received in DL, it may compare the currently measured channel occupancy and the previously reported channel occupancy. If the change between the currently measured channel occupancy and the previously reported channel occupancy is larger than a predefined threshold, which means that the channel occupancy has changed significantly, the network device (e.g., a gNB) may need a new report indicating the current channel occupancy to help perform the scheduling for the upcoming data transmission or receiving. It should be noted that, the comparison may be performed for a subband (e.g., an LBT subband, which is the frequency part with bandwidth equal to LBT bandwidth), a channel, a bandwidth part (BWP), a component carrier and/or a carrier, which is not limited.

It should also be noted that the above examples of conditions can be used alone or in any combination to trigger the on-demand report.

According to an embodiment, the terminal device generating the report may include measuring at least one parameter associated with the channel occupancy, e.g., by channel sensing, and the measurement may be performed over a slot, a mini-slot, a symbol, a radio frame or a predetermined period as desired. For example, the parameter may be LBT failure statistics, LBT success statistics, average receiving power, duty cycle, and so on. Accordingly, the generated report may include information related to the measurement results, e.g., information related to at least one of LBT failure statistics, LBT success statistics, average receiving power and duty cycle.

NR supports flexible bandwidth configurations for different terminal devices (e.g., different UEs) on the same serving cell. The bandwidth monitored by a UE and used for its control and data channels may be smaller than the carrier bandwidth. One or more BWP configurations for each component carrier can be semi-statically signaled to a UE, where each BWP consists of a group of contiguous physical resource blocks (PRBs). Reserved resources can be configured within the BWP. The bandwidth of a BWP may equal to or be smaller than the maximal bandwidth capability supported by a UE.

According to an embodiment, the report indicating the channel occupancy may be generated per subband (e.g., LBT subband), per channel, per BWP, per component carrier, or per carrier. For example, for wideband carrier comprising multiple LBT subbands or channels in a BWP, the report may be generated per LBT subband, per channel or per BWP. In another example, for a carrier aggregation scenario, the report may be generated per carrier. In the present disclosure, the term “channel” may sometimes be interpreted as representing an LBT subband, a BWP, a component carrier or a carrier according to the context.

According to an embodiment, the report may be generated only for the channels in an active BWP to save power for the terminal device. In this way, however, it is possible that the channels with better availability outside the active BWP cannot be scheduled. According to another embodiment, the report may be generated for all the channels within an active carrier, which may have a larger power consumption but increase the probability of scheduling a channel with high channel availability. According to another embodiment, the report may be generated for channels in a configured carrier. According to yet another embodiment, the report may be generated for channels in both the active carrier and one or more carriers corresponding to other serving cells.

According to an embodiment, the report may be transmitted only indicating the channel occupancy for a channel having the lowest channel occupancy. For example, when there is capacity limit for the report, the UE can generate the report only indicating the channel occupancy for the channel(s) with the lowest channel occupancy (i.e., with the best availability) while skipping the reports for the “bad” channels to reduce the report overhead. In an additional or alternative embodiment, the report for a channel/subband/BWP/carrier may be transmitted in another channel/subband/BWP/carrier in case the current serving channel/subband/BWP/carrier may be blocked by LBT failures or have a high channel occupancy, causing the possible loss of the report.

According to an embodiment, the report may be transmitted only indicating the channel occupancy for non-scheduled channels in order to reduce the overhead. For scheduled channels, it is possible that the serving network device can determine the channel availability based on the data transmission occurrence by the terminal device even without the relevant report.

According to an embodiment, the report may comprise a bitmap to indicate availability of one or more channels.

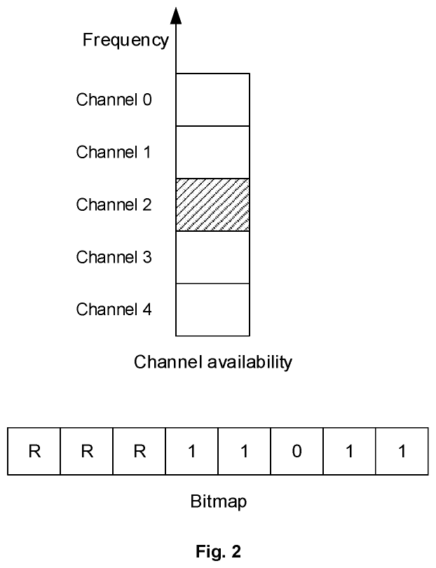

FIG. 2 is a schematic diagram illustrating an example bitmap used for the report, in which five channels are monitored by the terminal device. As shown in FIG. 2, according to the channel occupancy measurement, channel 2 is determined as unavailable (shown as shaded) while channels 0, 1, 3, 4 are determined as available. Accordingly, in the bitmap (an octet byte in FIG. 2) for the report, the available channels are represented by “1”s while the unavailable channel is represented by “0”. In this example, there are three reserved bits in the bitmap, which are indicated as “R”.

It should be noted that, although five channels and one byte are shown in FIG. 2 as an example, the channel occupancy of more or less channels can also be represented by the bitmap. For example, in the case where the channel occupancy measurement is performed for other serving cells or other BWPs, the bitmap may have a longer size (e.g., multiple bytes).

In this embodiment, as the channel occupancy of each channel is represented by only one bit, the overhead of the report can be greatly reduced.

The availability for a channel can be determined in various ways. For example, the terminal device can perform proactive channel sensing when a regular BSR is triggered. If the channel sensing indicates that no transmission occurs in the channel prior to the SR transmission, then the channel can be determined as available. In another example, if the duty cycle or the averaging receiving power of the channel over a predetermined time period is lower than a threshold, then the channel can be determined as available. In yet another example, if the number of LBT failures over a predetermined time period is less than a threshold or the number of LBT successes over a predetermined time period is more than a threshold, then the channel can be determined as available.

It should be noted that, although a bitmap is used and the channel occupancy of each channel is represented by only one bit in the above embodiment, more bits can be used to carry the channel occupancy for each channel, so as to provide more detailed information to the network device.

According to an embodiment, the report indicating the channel occupancy may be transmitted using a MAC CE. For example, a new MAC CE can be defined for the report, and the bitmap can be carried in the MAC CE to indicate the channel availability. In an embodiment, the MAC CE can be prioritized over data transmission in a MAC protocol data unit (PDU) when UL data in the transmit buffer of the terminal device exceeds the size of the MAC PDU according to the received UL grant(s), such that the report can be transmitted in the MAC PDU to assist the subsequent scheduling for the remaining UL data in the transmit buffer. On the other hand, if the MAC PDU according to the received UL grant(s) can accommodate all the buffered data, then the triggered on-demand report can be cancelled.

According to an embodiment, the report may be transmitted via physical uplink control channel (PUCCH). For example, the terminal device may send the report together with SR using the same PUCCH resource. The serving network device can then use the report to allocate the initial UL grant when the SR is received.

According to an embodiment, the report may be transmitted via a random access (RA) message. For example, the report may be transmitted via MsgA in a 2-step RA or Msg3 in a 4-step RA. The RA may be triggered if there is no available PUCCH SR resource for the terminal device while an SR is triggered.

According to an embodiment, the report may be transmitted via physical uplink shared channel (PUSCH). For example, the report can be transmitted in the same PUSCH as the regular BSR.

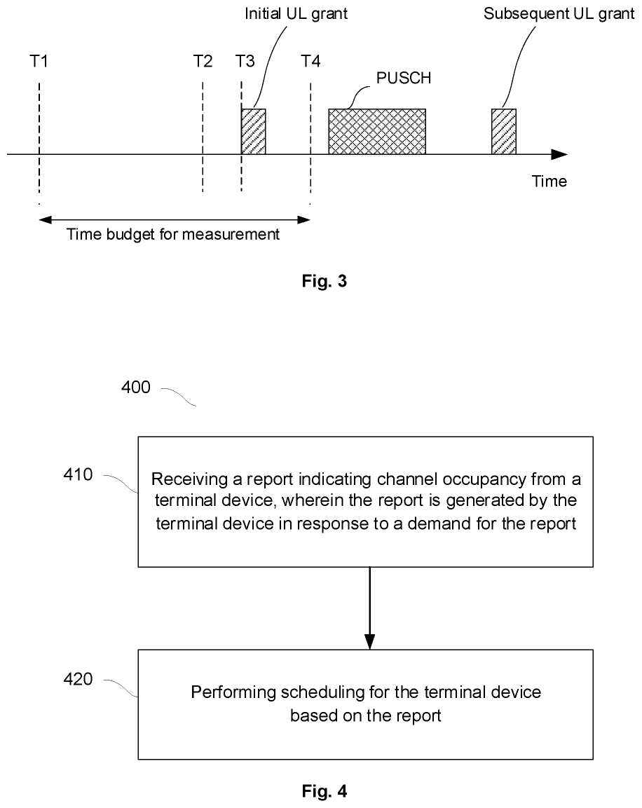

FIG. 3 is a schematic diagram showing an example procedure of UL data transmission at a terminal device according to embodiments of the present disclosure. In this example, an on-demand report is generated in response to a regular BSR being triggered, and the report is transmitted in the same PUSCH as the regular BSR.

As shown in FIG. 3, at time T1, a regular BSR is triggered at the terminal device. At time T2, an SR is transmitted by the terminal device. At time T3, the initial UL grant is received. At time T4, the terminal device starts the construction of the MAC PDU. After that, the MAC PDU is transmitted in the PUSCH, and subsequent UL grants are received.

In this example, the time budget for measuring the channel occupancy (e.g., measuring the duty cycle or average receiving power, performing tentative LBT channel sensing) is the period between T1 and T4. Once the measurement is completed, a report can be generated and packed into the MAC PDU, and then transmitted in the PUSCH.

In another example, in the case where there is no sufficient time for the terminal device to measure the channel occupancy (e.g., the period between T1 and T4 is not long enough to perform the measurement), the terminal device may send the report in a later PUSCH transmission. In this case, the report may still be useful considering that in a typical case, the terminal device may transmit a data burst instead of a single packet.

It should be noted that, although some embodiments and examples in the above are described in the context of NR-U, these embodiments are equally applicable to other scenarios with unlicensed spectrum, such as LTE License Assisted Access (LAA), enhanced LAA (eLAA), Further enhanced LAA (FeLAA), LTE-WLAN Aggregation (LWA), MulteFire, LTE-Railway (LTE-R), and so on.

FIG. 4 is a flowchart illustrating a method 400 according to embodiments of the present disclosure. The method 400 can be performed at a network device, e.g., a gNB or an eNB.

At block 410, a report indicating channel occupancy is received from a terminal device. The report may be generated by the terminal device in response to a demand for the report, as described above with respect to FIG. 1.

At block 420, the network device may perform scheduling for the terminal device based at least on the report. The network device may perform the scheduling using different scheduling schemes, which is not limited. For example, both dynamic scheduling and configured scheduling can be used for NR UL scheduling. For dynamic scheduling, the gNB allocates one or more UL grants for a UE based on the SR/BSR reception from this UE, while configured scheduling is used to allocate semi-static periodic assignments or grants for a UE.

As described above with respect to FIG. 1, in an embodiment, prior to block 410, the network device may transmit a message to the terminal device to enable the on-demand report. For example, prior to block 410, the network device may transmit a configuration message to the terminal device indicating parameters of the report.

According to an embodiment, the method 400 may further include transmitting a notification to the terminal device informing information of the scheduling, such that the terminal device can perform data transmission or data receiving accordingly.

More details of the method 400 are similar to those described above with respect to FIGS. 1-3 and thus are omitted here.

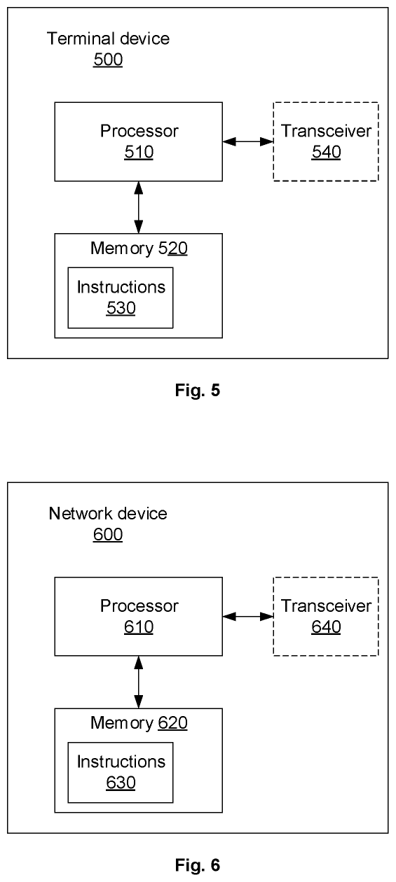

FIG. 5 is a block diagram of a terminal device 500 according to embodiments of the present disclosure.

The terminal device 500 includes a processor 510 and a memory 520. Optionally, the terminal device 500 may further include a transceiver 540 coupled to the processor 510. The memory 520 contains instructions 530 executable by the processor 510 to cause the terminal device 500 to perform the actions of the method 100. Particularly, the memory 520 may contain instructions that, when executed by the processor 510, cause the terminal device 500 to determine a demand to transmit a report indicating channel occupancy, generate the report indicating the channel occupancy in response to the demand, and transmit the report to a network device.

According to an embodiment, the demand may correspond to a need to perform data transmission or receiving by the terminal device.

According to an embodiment, the memory 520 may further contain instructions 530 that, when executed by the processor 510, cause the terminal device 500 to receive a notification from the network device informing scheduling information for the terminal device, wherein the scheduling information is determined based at least on the report.

According to an embodiment, the demand may be determined in response to at least one of: a SR being triggered; a regular BSR being triggered; a periodic BSR being triggered which indicates an existence of buffered data for uplink (UL) transmission; receiving from the network device a notification that requests the report indicating the channel occupancy; receiving from the network device the first DCI of one or more DCIs for UL grants or DL assignments; an expiration of a previous report and an existence of data to be transmitted in UL or to be received in DL; and a change between a current channel occupancy and a previously reported channel occupancy beyond a threshold and an existence of data to be transmitted in UL or to be received in DL.

According to an embodiment, the notification that requests the report indicating the channel occupancy may be carried in DCI, MAC CE and/or RRC signaling.

According to an embodiment, the report may comprise a bitmap to indicate availability of one or more channels.

According to an embodiment, the report may be transmitted using a MAC CE.

According to an embodiment, the MAC CE may be prioritized over data transmission in a MAC PDU when UL data in a transmit buffer of the terminal device exceeds a size of the MAC PDU.

According to an embodiment, the report may be transmitted via at least one of: PUCCH, PUSCH, and RA message.

According to an embodiment, the report may be transmitted only indicating the channel occupancy for a channel having a lowest channel occupancy and/or for non-scheduled channels.

According to an embodiment, the report may be generated for one of the following: channels in an active BWP; channels in an active carrier; channels in a configured carrier; and channels in an active carrier and one or more carriers corresponding to other serving cells.

According to an embodiment, the report may comprise information related to at least one of: LBT failure statistics, LBT success statistics, average receiving power, and duty cycle.

According to an embodiment, the report may be generated per subband, per channel, per BWP, per component carrier or per carrier.

According to an embodiment, generating the report may comprise: measuring at least one parameter associated with the channel occupancy over a slot, a mini-slot, a symbol, a radio frame or a predetermined period.

It should be noted that, more details described with reference to FIGS. 1-4 are also applicable here and may be omitted.

FIG. 6 is a block diagram of a network device 600 according to embodiments of the present disclosure.

The network device 600 includes a processor 610 and a memory 620. Optionally, the network device 600 may further include a transceiver 640 coupled to the processor 610. The memory 620 contains instructions 630 executable by the processor 610 to cause the network device 600 to perform the actions of the method 400. Particularly, the memory 620 may contain instructions 630 that, when executed by the processor 610, cause the network device 600 to receive a report indicating channel occupancy from a terminal device and perform scheduling for the terminal device based at least on the report. The report may be generated by the terminal device in response to a demand for the report.

Further details about the network device 600 are similar to those described with respect to the terminal device 500 and thus are omitted here. It should also be noted that, the details described with reference to FIGS. 1-4 are also applicable here and may be omitted.

The memories 520 and 620 may be of any type suitable to the local technical environment and may be implemented using any suitable data storage technology, such as semiconductor-based memory terminal devices, magnetic memory terminal devices and systems, optical memory terminal devices and systems, fixed memory and removable memory, as non-limiting examples.

The processors 510 and 610 may be of any type suitable to the local technical environment, and may include one or more of general purpose processors, special purpose processors (e.g., Application Specific Integrated Circuit (ASICs)), microprocessors, digital signal processors (DSPs) and processors based on multicore processor architecture, as non-limiting examples.

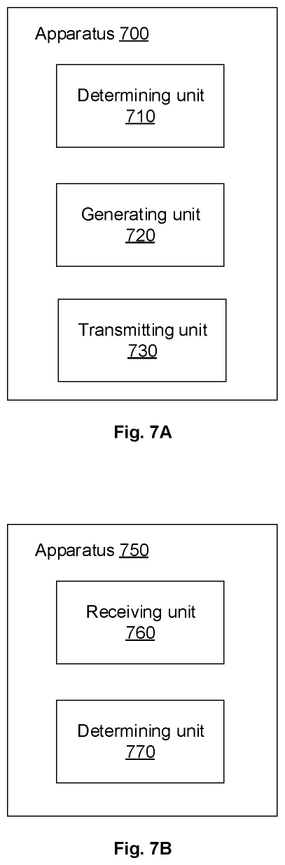

FIG. 7A is a block diagram of an apparatus 700 according to embodiments of the present disclosure, which can be configured to perform the method 100 as described in connection with FIG. 1.

The apparatus 700 may include a determining unit 710, a generating unit 720 and a transmitting unit 730. The determining unit 710 may be configured to determine a demand to transmit a report indicating channel occupancy. The generating unit 720 may be configured to generate the report indicating the channel occupancy in response to the demand. The transmitting unit 730 may be configured to transmit the report to a network device.

The apparatus 700 can be implemented as the terminal device 500 or as a software and/or a physical device within the terminal device 500 or communicatively coupled to the terminal device 500.

Further details about the apparatus 700 are similar to those described with respect to FIGS. 1-4 and are omitted here.

FIG. 7B is a block diagram of an apparatus 750 according to embodiments of the present disclosure, which can be configured to perform the method 400 as described in connection with FIG. 4.

The apparatus 750 may include a receiving unit 760 and a scheduling unit 770. The receiving unit 760 may be configured to receive a report indicating channel occupancy from a terminal device and the scheduling unit 770 may be configured to perform scheduling for the terminal device based at least on the report. The report may be generated by the terminal device in response to a demand for the report

The apparatus 750 can be implemented as the network device 600 or as a software and/or a physical device within the network device 600 or communicatively coupled to the network device 600.

Further details about the apparatus 750 are similar to those described with respect to FIGS. 1-4 and are omitted here.

The units as described in FIGS. 7A and 7B may be implemented as software and/or hardware, or a device comprising the software and/or the hardware, which is not limited. For example, they can be implemented as computer readable programs that can be executed by a processor. Alternatively, they can be implemented as processing circuitry such as ASICs and/or field programmable gate arrays (FPGAs).

The present disclosure may also provide computer readable media having instructions thereon. The instructions, when executed by a processor of a network device or a terminal device, cause the network device or terminal device to perform the method according to the embodiments as described above. The computer readable media may include computer-readable storage media, for example, magnetic disks, magnetic tape, optical disks, phase change memory, or an electronic memory terminal device like a random access memory (RAM), read only memory (ROM), flash memory devices, CD-ROM, DVD, Blue-ray disc and the like. The computer readable media may also include computer readable transmission media (also called a carrier), for example, electrical, optical, radio, acoustical or other form of propagated signals-such as carrier waves, infrared signals, and the like.

The present disclosure may also provide computer program products including instructions. The instructions, when executed by a processor of a terminal device or a network device, cause the terminal device or the network device to perform the method according to the embodiments as described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, units, apparatus, systems, techniques or methods described herein may be implemented in, as non-limiting examples, hardware, software, firmware, special purpose circuits or logic, general purpose hardware or controller or other computing devices, or some combination thereof.

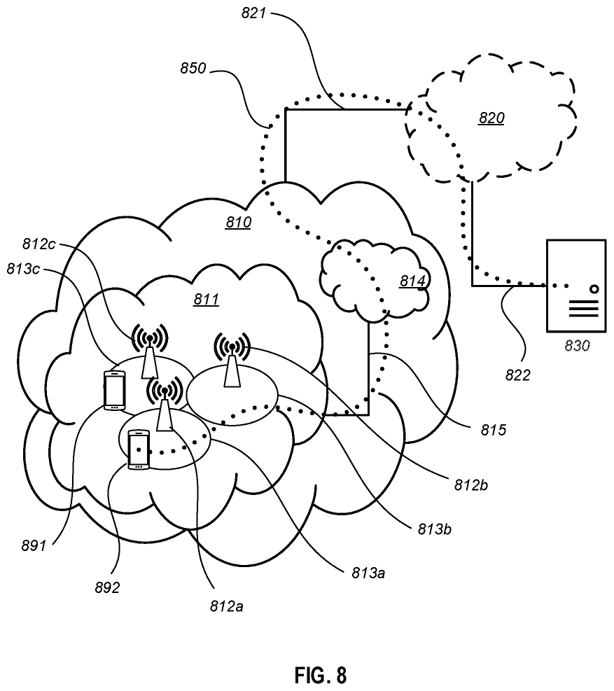

With reference to FIG. 8, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first user equipment (UE) 891 located in coverage area 813c is wirelessly connected to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connected to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. The connections 821, 822 between the telecommunication network 810 and the host computer 830 may extend directly from the core network 814 to the host computer 830 or may go via an optional intermediate network 820. The intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between one of the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, a base station 812 may not or need not be informed about the past routing of an incoming downlink communication with data originating from a host computer 830 to be forwarded (e.g., handed over) to a connected UE 891. Similarly, the base station 812 need not be aware of the future routing of an outgoing uplink communication originating from the UE 891 towards the host computer 830.

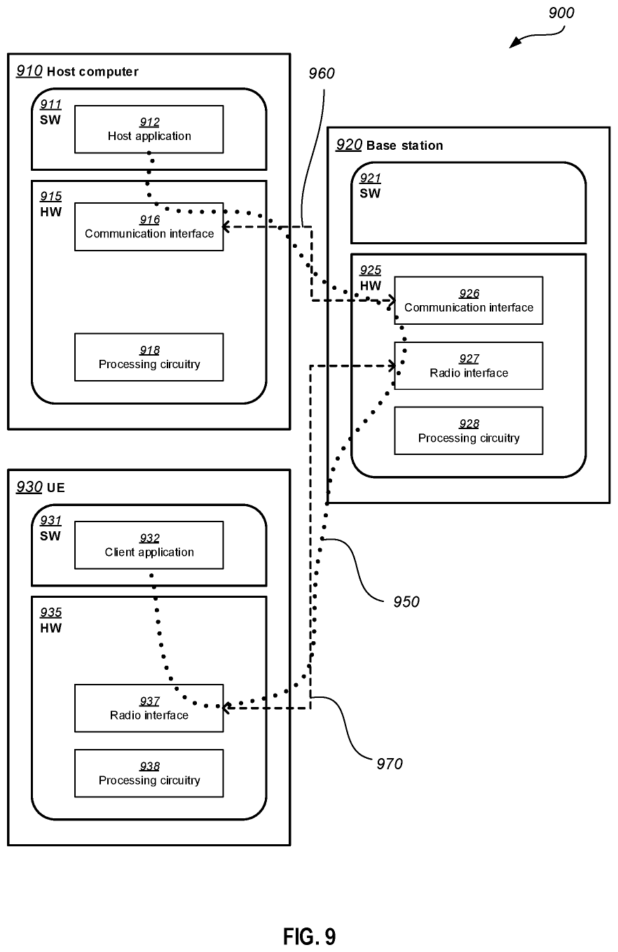

Example implementations, in accordance with an embodiment, of the UE, base station and host computer discussed in the preceding paragraphs will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as a UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with a UE 930 located in a coverage area (not shown in FIG. 9) served by the base station 920. The communication interface 926 may be configured to facilitate a connection 960 to the host computer 910. The connection 960 may be direct or it may pass through a core network (not shown in FIG. 9) of the telecommunication system and/or through one or more intermediate networks outside the telecommunication system. In the embodiment shown, the hardware 925 of the base station 920 further includes processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, base station 920 and UE 930 illustrated in FIG. 9 may be identical to the host computer 830, one of the base stations 812a, 812b, 812c and one of the UEs 891, 892 of FIG. 8, respectively. This is to say, the inner workings of these entities may be as shown in FIG. 9 and independently, the surrounding network topology may be that of FIG. 8.

In FIG. 9, the OTT connection 950 has been drawn abstractly to illustrate the communication between the host computer 910 and the user equipment 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

The wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the efficiency of scheduling and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 950 between the host computer 910 and UE 930, in response to variations in the measurement results. The measurement procedure and/or the network functionality for reconfiguring the OTT connection 950 may be implemented in the software 911 of the host computer 910 or in the software 931 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer's 910 measurements of throughput, propagation times, latency and the like. The measurements may be implemented in that the software 911, 931 causes messages to be transmitted, in particular empty or ‘dummy’ messages, using the OTT connection 950 while it monitors propagation times, errors etc.

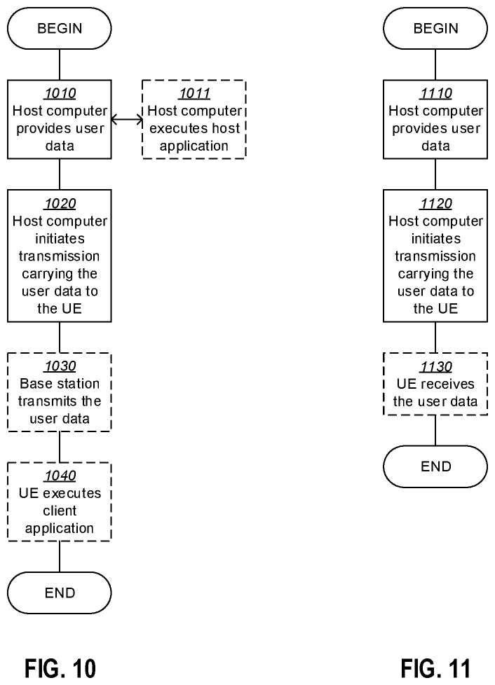

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 1010 of the method, the host computer provides user data. In an optional substep 1011 of the first step 1010, the host computer provides the user data by executing a host application. In a second step 1020, the host computer initiates a transmission carrying the user data to the UE. In an optional third step 1030, the base station transmits to the UE the user data which was carried in the transmission that the host computer initiated, in accordance with the teachings of the embodiments described throughout this disclosure. In an optional fourth step 1040, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 1110 of the method, the host computer provides user data. In an optional substep (not shown) the host computer provides the user data by executing a host application. In a second step 1120, the host computer initiates a transmission carrying the user data to the UE. The transmission may pass via the base station, in accordance with the teachings of the embodiments described throughout this disclosure. In an optional third step 1130, the UE receives the user data carried in the transmission.

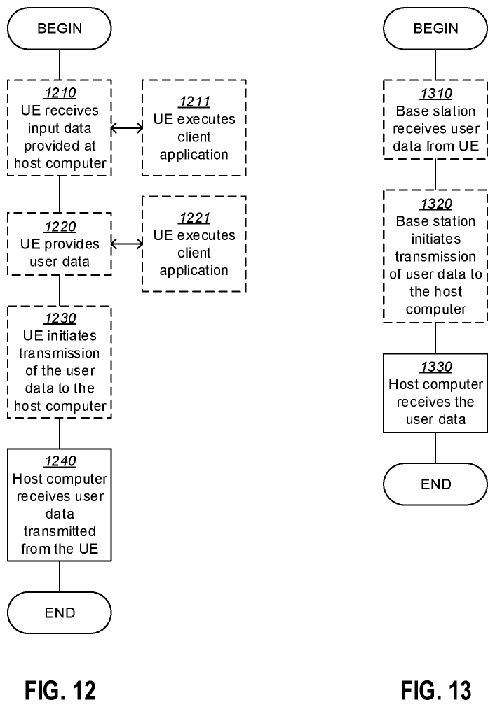

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 1210 of the method, the UE receives input data provided by the host computer. Additionally or alternatively, in an optional second step 1220, the UE provides user data. In an optional substep 1221 of the second step 1220, the UE provides the user data by executing a client application. In a further optional substep 1211 of the first step 1210, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1230, transmission of the user data to the host computer. In a fourth step 1240 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 1310 of the method, in accordance with the teachings of the embodiments described throughout this disclosure, the base station receives user data from the UE. In an optional second step 1320, the base station initiates transmission of the received user data to the host computer. In a third step 1330, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1-40. (canceled)

41. A method at a terminal device, comprising the terminal device:
determining a demand to transmit a report indicating channel occupancy;
generating the report indicating the channel occupancy in response to the demand; and
transmitting the report to a network device.

42. The method of claim 41, wherein the demand corresponds to a need to perform data transmission or receiving by the terminal device.

43. The method of claim 41, further comprising receiving a notification from the network device informing scheduling information for the terminal device, wherein the scheduling information is determined based on the report.

44. The method of claim 41, wherein the demand is determined in response to:
a schedule request (SR) being triggered;
a regular buffer status report (BSR) being triggered;
a periodic BSR being triggered which indicates an existence of buffered data for uplink (UL) transmission;
receiving from the network device a notification that requests the report indicating the channel occupancy;
receiving, from the network device, first downlink control information (DCI) of one or more DCIs for UL grants or downlink (DL) assignments;
an expiration of a previous report and an existence of data to be transmitted in UL or to be received in DL; and/or
a change between a current channel occupancy and a previously reported channel occupancy beyond a threshold and an existence of data to be transmitted in UL or to be received in DL.

45. The method of claim 44, wherein the notification that requests the report indicating the channel occupancy is carried in DCI, media access control (MAC) control element (MAC CE), and/or radio resource control (RRC) signaling.

46. The method of claim 41, wherein the report comprises a bitmap to indicate availability of one or more channels.

47. The method of claim 41, wherein the report is transmitted using a media access control (MAC) control element (MAC CE).

48. The method of claim 47, wherein the MAC CE is prioritized over data transmission in a MAC protocol data unit (PDU) when uplink (UL) data in a transmit buffer of the terminal device exceeds a size of the MAC PDU.

49. The method of claim 41, wherein the report is transmitted via: a physical uplink control channel (PUCCH), a physical uplink shared channel (PUSCH), and/or a random access (RA) message.

50. The method of claim 41, wherein the report is transmitted only indicating the channel occupancy for a channel having a lowest channel occupancy and/or for non-scheduled channels.

51. The method of claim 41, wherein the report is generated for one of the following: channels in an active bandwidth part (BWP); channels in an active carrier; channels in a configured carrier; and channels in an active carrier and one or more carriers corresponding to other serving cells.

52. The method of claim 41, wherein the report comprises information related to: listen-before-talk (LBT) failure statistics, LBT success statistics, average receiving power, and/or duty cycle.

53. The method of claim 41, wherein the report is generated per subband, per channel, per bandwidth part (BWP), per component carrier, or per carrier.

54. The method of claim 41, wherein the generating the report comprises measuring at least one parameter associated with the channel occupancy over a slot, a mini-slot, a symbol, a radio frame, or a predetermined period.

55. The method of claim 41, further comprising receiving, prior to the determining and from the network device, a message to enable the report indicating the channel occupancy.

56. The method of claim 55, wherein the message comprises parameters to configure triggering, generation, and/or transmission of the report.

57. A method at a network device, comprising the network device:
receiving a report indicating channel occupancy from a terminal device, wherein the report is generated by the terminal device in response to a demand for the report; and
performing scheduling for the terminal device based at least on the report.

58. The method of claim 57, further comprising transmitting a notification to the terminal device informing information of the scheduling.

59. The method of claim 57, further comprising transmitting, prior to the receiving, a message to the terminal device to enable the report indicating the channel occupancy.

60. A terminal device, comprising:
processing circuitry;
memory containing instructions executable by the processing circuitry whereby the terminal device is operative to:
determine a demand to transmit a report indicating channel occupancy;
generate the report indicating the channel occupancy in response to the demand; and
transmit the report to a network device.
